(19) United States
(12) Patent Application Publication
(10) Pub. No.: US 2009/0178538 A1
(43) Pub. Date: Jul. 16, 2009

(54) TAMBOURINE WITH SOUND MUTING SYSTEM

(76) Inventor: Jan Roelof van der MEULEN, Brunssum (NL)

Correspondence Address: BERENATO, WHITE & STAVISH, LLC, 6550 ROCK SPRING DRIVE, SUITE 240, BETHESDA, MD, 20817, US

(21) Appl. No.: 12/055,449

(22) Filed: Mar. 26, 2008

Related U.S. Application Data
(60) Provisional application No. 61/006,503, filed on Jan. 16, 2008.

(51) Int. Cl. G10D 13/02

(52) U.S. Cl. 84/418

(57) ABSTRACT

A musical instrument comprising: a main body mounting a plurality of jingles to produce sound when said main body is vibrated as with a conventional tambourine. At least one muting element is associated with at least one of the jingles to selectively restricting movement of the jingles to mute a jingle sound produced by said jingles. In the preferred embodiment, the jingles are comprised of pairs of metallic discs carried by the main body. With the invention, the jingles can be selectively opened, either fully or partially, by the amount of pressure applied by the muting elements thus controlling an amount of jingle sound.

### CROSS-REFERENCE TO RELATED APPLICATION

This Application claims the benefit under 35 U.S.C. 119(e) of U.S. Provisional Application No. 61/006,503 filed Jan. 16, 2008 by Jan Roelof van der Meulen.

### BACKGROUND OF THE INVENTION

1. Field of the Invention

This invention relates generally to tambourines, and more particularly to improvements in tambourines enabling their play to produce selectively different sounds.

2. Description of Related Art

It is often desirable to accompany the sounding of a drum or other percussion instrument with the shimmering sound of a plurality of moving disks, bells, or other jingles. Tambourines conventionally comprise a looping frame and multiple like jingles carried by the frame to produce like jingling sounds when the tambourine is shaken or struck.

Tambourines typically come in “single row” (FIG. 1) or “double row” (FIG. 2) configurations of jingles. The more jingles a tambourine has the more jingle “sound” and loudness it will have thus making it ideal for applications requiring loudness and full-bodied tambourine sound such as in concerts. Precise control of the jingle sound is not critical due to masking by other instruments. Fewer jingles are ideal for applications requiring less volume and especially in recording studios where microphones are placed next to the tambourine. In the studio, precision is more important than loudness and fewer jingles are easier to control precisely by the percussionist.

To cover both general applications, the percussionist must own at least two tambourines: one for “loud” and another for “intimate” or studio situations; but the conventional tambourine may not be adequate for all situations.

Thus there's a need for a single tambourine with adjustable jingle sound that can accommodate all types of playing situations from concert to intimate to studio.

### SUMMARY OF THE INVENTION

A musical instrument in the form of a tambourine comprises a main body; a plurality of jingles mounted on the main body in a conventional manner to produce sound when the main body is vibrated. The jingles comprised of pairs of metallic discs carried by the main body. In accordance with the invention, a muting element is associated with at least one of the pairs of metallic discs, such that the muting element selectively restricting movement of said metallic discs to mute a sound produced by the jingles.

In the preferred embodiment, the muting element comprises an adjustable resilient member in the form of an o-ring adjustably positioned on a support pin with respect to the metallic discs to restrict movement of the metallic discs. The invention contemplates other types of muting systems in accordance with the spirit and scope of the invention.

These and other objects and advantages of the invention, as well as the details of an illustrative embodiment, will be more fully understood from the following specification and drawings, in which:

### BRIEF DESCRIPTION OF THE DRAWINGS

FIG. 1 is a perspective view of conventional tambourine having a single row of jingles;

FIG. 2 is a perspective view of a conventional tambourine having a double row of jingles;

FIG. 3 is a front elevation view of a conventional tambourine;

FIG. 4 is a partial sectional view taken on lines 4-4 of FIG. 3;

FIG. 5 is a partial sectional view as shown in FIG. 4 incorporating the muting system of the present invention and showing the jingles in the non-muted position;

FIG. 6 is a partial sectional view as shown in FIG. 4 incorporating the muting system of the present invention and showing the jingles in the fully-muted position;

FIG. 7 is a perspective view of a double row tambourine incorporating the muting system of the present invention.

### DETAILED DESCRIPTION OF THE PREFERRED EMBODIMENTS

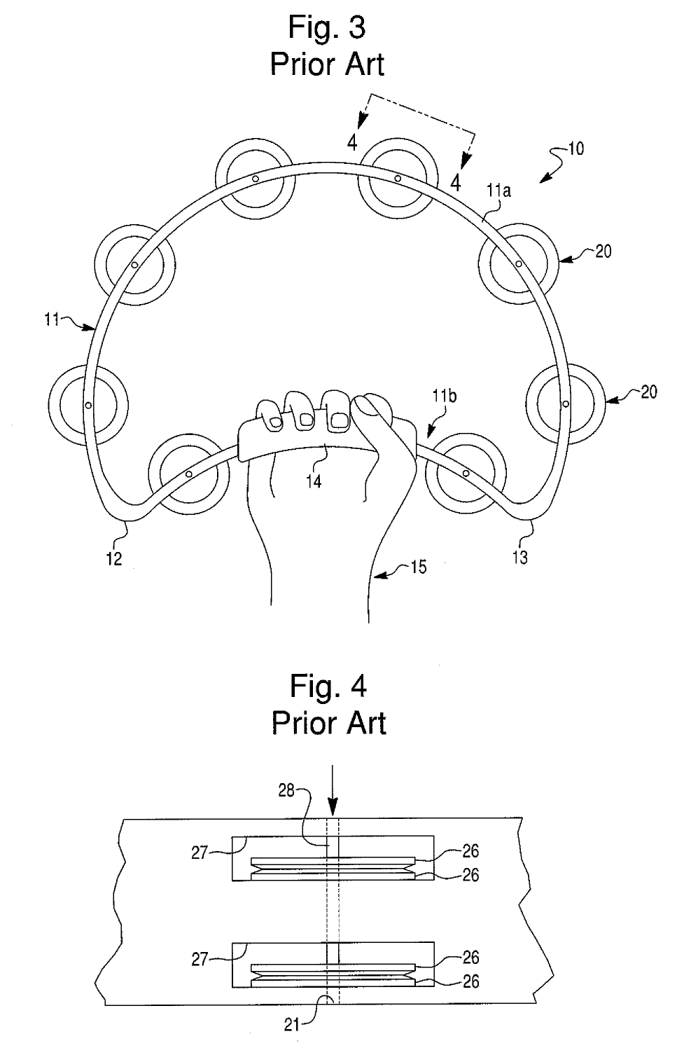

In FIGS. 3-4, a preferred tambourine 10 has a frame 11 that forms a generally crescent overall shape, and which includes a first portion 11a that extends in part along a semi-circular path between corners 12 and 13. The semi-circular path is outwardly convex, as shown. The frame has a handle portion 11b that extends between corners 12 and 13. That path is outwardly concave. Portion 11b includes a handle indicated at 14, close to the center of gravity of the tambourine, so that the instrument is easy to manually manipulate. Note the user's hand indicated generally at 15, for shaking the tambourine back and forth, whereby jingles 20 on the tambourine produce their characteristic jingling sound. They also produce a sudden impact sound when the tambourine frame is impacted against an object such as the player's other hand.

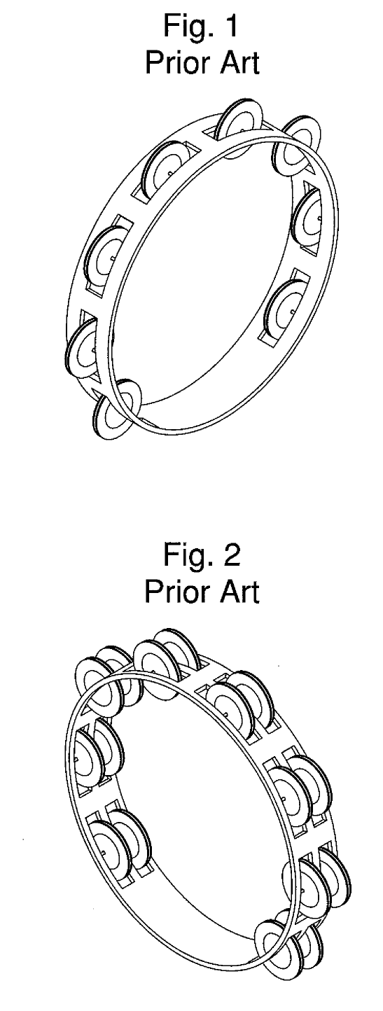

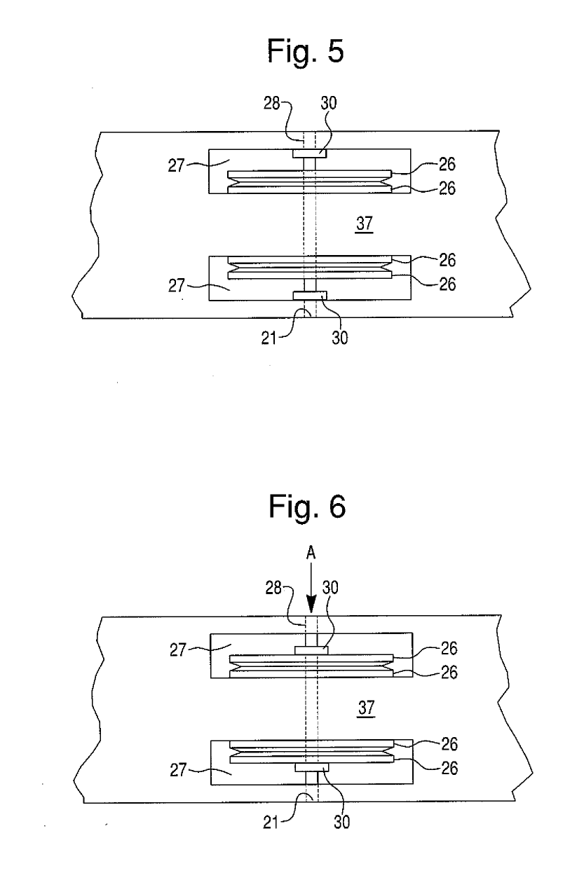

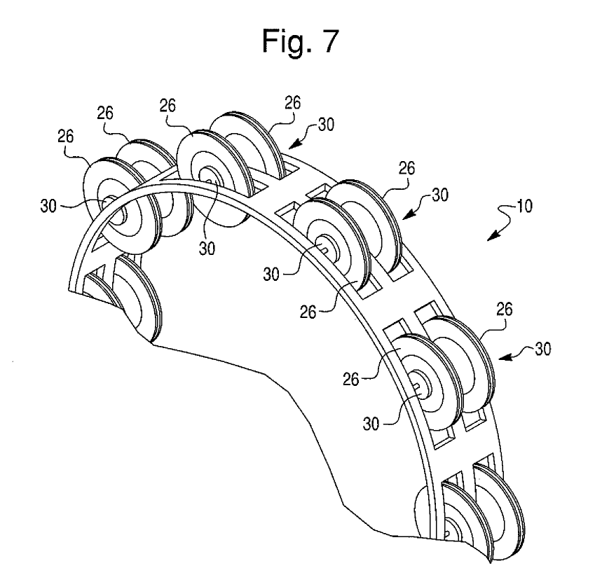

The jingles 20 typically comprise pairs of metallic discs 26 carried within slots 27 of the frame. The pairs of discs are loosely received on carrier pins 28 attached to the frame, as is clear from FIG. 4, whereby the thin metallic discs of each pair slide back and forth on the pins and strike each other to produce the characteristic jingling sound, represented by an audible frequency range, as the tambourine is displaced back and forth. The jingles are carried at selected locations along the frame path or paths, as seen in FIG. 3 and 7. In the illustrated version of FIGS. 3-6, two pairs of jingles are carried at each selected location. As is clear from FIGS. 5 and 6, two slots 27 are formed in the frame at such locations. However, the present invention is equally useful and applicable to tambourines having a single row of jingles as illustrated in FIG. 1. With both arrangements, the pins 28 extend normal to the plane of the frame.

In accordance with this invention, muting elements 30 are disposed on the tambourine to mute the sound of the metallic discs 26 depending on selective placement of the muting elements 30. In FIG. 6, the jingles 26 are shown in the totally muted position. In the preferred embodiment, rubber o-rings 30 are disposed on the pins 28. When the o-rings 30 are pressed against the jingles in the direction of the arrow A, the jingles 26 are pressed against the strut member 37 separating the two openings 27 or the side wall of the openings 27 for the jingles in the tambourine body. This restricts the movement of the jingles 26 thus muting the sound.

Each pair of jingles 26 can be selectively “opened,” either fully or partially (infinitely), by the amount of pressure applied by the o-rings 30 thus controlling the amount of jingle sound.

When all of the o-rings 30 are fully “off,” the jingles 26 are in the non-muted position as shown in FIG. 5 and the tambourine will be restored to its maximum sound volume potential. When all of the o-rings 30 are fully “on” or engaged, the jingles 26 are in the muted position as shown in FIG. 6 and the tambourine is selectively muted depending on the amount of pressure applied to the jingles 26. In accordance with the invention, the jingles 26 may be partially muted or fully muted depending on the pressure applied by the o-rings 30.

FIG. 7 illustrates in perspective view the muting system of the present invention disposed on a double jingle type tambourine.

Although the invention has been described with reference to the preferred embodiments illustrated in the drawings, it is noted that equivalents may be employed and substitutions made herein without departing from the scope of the invention as recited in the claims. In particular, as mentioned, the jingles are not limited to metal disks and may instead be of any desired type, such as, for example, bells or pieces of shell. Further, the position of the o-rings 30 may be at any location relative to the jingles 26 as long as the muting elements are permitted to contact the jingles 26 in the muted position. Additionally, the preferred embodiment of the invention employs o-rings 30 as muting elements; however, other types of muting elements may be used to control the amount and type of jingle sound. For example, a muting element may be mounted in the slots 27 to likewise engage the jingles in a muted condition or a threaded element may be turned to adjust an amount of muting achieved for the jingles 26.

1. A musical instrument comprising:
a main body;
a plurality of jingles mounted on said main body to produce sound when said main body is vibrated;
a muting element associated with at least one of said jingles, said muting element selectively restricting movement of said jingles to mute a jingle sound produced by said jingles.

2. The instrument according to claim 1, wherein said jingles comprised of pairs of metallic discs carried by said main body.

3. The instrument according to claim 1, wherein said jingles comprise non-metallic elements mounted to vibrate and produce sound when the main body is vibrated.

4. The instrument according to claim 2, wherein said muting element comprising an adjustable resilient member adjustably positioned with respect to said jingles to restrict movement of said metallic discs.

5. The instrument according to claim 1, wherein said muting element is formed as a resilient o-ring having a circular configuration.

6. The instrument according to claim 1, further comprising a pin supporting said jingles on said main body.

7. The instrument according to claim 6, wherein said muting elements comprise an adjustable resilient member adjustably positioned on said pin.

8. The instrument according to claim 2, wherein said muting element presses said metallic element against a strut formed on said main body.

9. The instrument according to claim 1, wherein said muting element reduces an amount of vibration of said jingles.

10. The instrument according to claim 1, wherein each jingle is provided with a muting element.

11. The instrument according to claim 2, wherein said pairs of metallic elements are mounted within slots provided on said main body.

12. The instrument according to claim 2, wherein said jingles can be selectively opened, either fully or partially, by the amount of pressure applied by the muting elements thus controlling an amount of jingle sound.
